(19) United States
(12) Patent Application Publication
(10) Pub. No.: US 2021/0214193 A1
(43) Pub. Date: Jul. 15, 2021

(54) APPARATUS AND METHOD FOR HANDLING BULK MATERIALS

(71) Applicant: BULK INNOVATIONS PTY LTD, Milton (AU)

(72) Inventor: Daryl Gordon GRAY, Henley Beach (AU)

(21) Appl. No.: 17/170,159

(22) Filed: Feb. 8, 2021

Related U.S. Application Data
(63) Continuation of application No. PCT/AU2019/050816, filed on Aug. 6, 2019.

(30) Foreign Application Priority Data
Aug. 7, 2018 (AU) 2018902876

(51) Int. Cl. B66C 3/14; A01G 23/00; B66C 1/62; B66C 1/22

(52) U.S. Cl. CPC B66C 3/14; B66C 1/22; B66C 1/62; A01G 23/003

(57) ABSTRACT

An apparatus for handling bulk material, the apparatus comprising a spreader configured for attachment to a crane, the spreader having a spreader body having a first engagement formation. The apparatus includes a bulk material storage cradle having a first side member and a second side member, the first and second side members defining two opposing longitudinal side walls which are spaced relative to each other to define an internal bulk material storage receptacle. The bulk material storage cradle has a second engagement formation, and at least one gate member having a proximal end hingedly connected to a lower portion of the first side member and a distal end having a third engagement formation configured to selectively engage with a fourth engagement formation located at a lower portion of the second side member. The first engagement formation is selectively engageable with the second engagement formation to secure the spreader to the bulk material storage cradle. The third engagement formation is selectively disengageable from the fourth engagement formation to release the gate member from the second side member.

### TECHNICAL FIELD

The present invention relates to an apparatus and method for handling bulk materials. In particular, the present invention relates to an apparatus for handling timber logs during transportation and ship loading. However, it will be appreciated that the invention may be used in respect of other bulk materials.

### BACKGROUND OF THE INVENTION

Cut logs are often transported from the forest to the port and loaded into ships for transport overseas for further processing. At the port, the logs are received and unloaded from trucks and stored in open stacks. They are later re-handled and transported to the quay side and loaded into a support frame (bunk) to form a bundle. These bundles are loaded by a crane using wire or chains slings attached to the crane. To secure the slings around the bundle, stevedores manually loop the slings around the bundle of logs. In practice, two stevedores are normally used to handle the sling placement.

Once the logs are loaded into the hatch of the ship, the wire/chain slings are unlocked by gravity, freeing the logs from the lifting equipment. An excavator is then used within the hatch of the ship to arrange the logs in desired positions. This process is used to optimise the log placement and to reduce the likelihood of undesirable movement of the logs during the journey.

The unloading, storing and re-handling of logs is costly. Furthermore, the wharf side loading process can be a dangerous and labour intensive process.

Logs are loaded onto ships with cranes. The cranes are either shore based or ship based. The shore-based cranes normally use grabs and do not use men at the quay side to attach the load. Shore-based cranes have higher capacity and increased productivity with grabs but are very expensive to purchase and maintain. In contrast, ship based cranes are more economically competitive, because operators can use three to four cranes during loading and there are no capital costs for the port operator. However, ship cranes may use the aforementioned manual slinging of the load. This is a time consuming and labour intensive manual process.

Accordingly, it would be desirable to use the ship's cranes and to remove the manual intervention.

Other techniques for loading logs such as grabs allow automated pick-up, but reduce the capacity of the ships crane as the grab equipment is heavy, and therefore reduces the maximum payload of logs, as a reasonable percentage of the crane's maximum capacity (typically 25-35 ton limit) is allocated to the weight of the grab, due to the considerable weight of the grab components such as the motor and oil.

For these reasons, it would be desirable to deploy a light weight attachment to the crane to maximize the load but to remove the need for manual slinging.

Furthermore, drawbacks exist with the handling of other bulk materials, such as scrap metal, coal, ores and various grains and cereals.

### OBJECT OF THE INVENTION

It is an object of the present invention to substantially overcome or at least ameliorate one or more of the above disadvantages, or to provide a useful alternative.

### SUMMARY OF THE INVENTION

In an aspect, the present disclosure provides an apparatus for handling bulk materials, the apparatus comprising:

a spreader configured for attachment to a crane, the spreader having a spreader body having a first engagement formation; and

a bulk material storage cradle having:
a first side member and a second side member,
a second engagement formation disposed at a top portion of the first side member and a top portion of the second side member, wherein the first engagement formation is selectively engageable with the second engagement formation to secure the spreader to the bulk material storage cradle, and
at least one gate member having a proximal end hingedly connected to a lower portion of the first side member and a distal end having a third engagement formation configured to selectively engage with a fourth engagement formation located at a lower portion of the second side member;
wherein the first side member and the second side member are selectively connectable via at least one of: the spreader when the first engagement formation is engaged with the second engagement formation; and the gate member when the third engagement formation is engaged with the fourth engagement formation,

wherein, when the first and the second side members are connected via at least one of the spreader and the gate member, the first and the second side members are spaced relative to each other and define two opposing longitudinal side walls of the bulk material storage cradle and form an internal bulk material storage receptacle

further wherein the third engagement formation is selectively disengageable from the fourth engagement formation to release the gate member from the second side member.

There is also disclosed a bulk material storage cradle having:
a first side member and a second side member,
a second engagement formation disposed at a top portion of the first side member and a top portion of the second side member, wherein the second engagement formation is adapted to be selectively engageable with a first engagement formation of a spreader to secure the bulk material storage cradle to the spreader, and
at least one gate member having a proximal end hingedly connected to a lower portion of the first side member and a distal end having a third engagement formation configured to selectively engage with a fourth engagement formation located at a lower portion of the second side member;

wherein the first side member and a second side member are selectively connectable via at least one of: the spreader when the first engagement formation is engaged with the second engagement formation; and the gate member when the third engagement formation is engaged with the fourth engagement formation,

wherein, when the first and the second side members are connected via at least one of the spreader and the gate member, the first and the second side members are spaced relative to each other and define two opposing longitudinal side walls of the bulk material storage cradle and form an internal bulk material storage receptacle;

further wherein the third engagement formation is selectively disengageable from the fourth engagement formation to release the gate member from the second side member.

There is also disclosed an apparatus for handling bulk materials, the apparatus comprising:

a spreader configured for attachment to a crane, the spreader having a spreader body having a first engagement formation; and

a bulk material storage cradle having:
a first side member and a second side member, the first and second side members defining two opposing longitudinal side walls which are spaced relative to each other to define an internal bulk material storage receptacle,
a second engagement formation, and
at least one gate member having a proximal end hingedly connected to a lower portion of the first side member and a distal end having a third engagement formation configured to selectively engage with a fourth engagement formation located at a lower portion of the second side member;

wherein the first engagement formation is selectively engageable with the second engagement formation to secure the spreader to the bulk material storage cradle;

further wherein the third engagement formation is selectively disengageable from the fourth engagement formation to release the gate member from the second side member,

wherein the bulk material storage cradle further has a secondary actuation mechanism interfacing with and operable from the spreader, one of the third and fourth engagement formations is selectively controllable by the secondary actuation mechanism, such that the one of the third and fourth engagement formations is released to open the gate member.

The secondary actuation mechanism preferably includes a vertically extending shaft which extends through the second side member, an upper end of the shaft being engageable by a male projection of the spreader and a lower end of the shaft being connected to the fourth engagement formation.

Preferably the third engagement formation is an aperture and the fourth engagement formation is a male twistlock.

The apparatus further preferably comprises a transport storage frame, the transport storage frame including a rigid base frame and four vertically extending corner posts.

The rigid base and corner posts preferably define a receptacle configured to receive the bulk material storage cradle.

The transport storage frame preferably includes a plurality of guide surfaces, the guide surfaces are configured to interact with corresponding abutment formations of the bulk material storage cradle during nesting.

The guide surfaces are preferably located on angularly inclined projections, and the abutment formations are defined by complimentary inclined surfaces located on projections located at or near a bottom of each of the first and second side members of the bulk material storage cradle.

The rigid base frame preferably includes a skid surface located directly beneath each gate member and configured to guide the gate member from an open position to a closed position as the bulk material storage cradle is lowered into the transport storage frame.

An abutment projection preferably restricts an angle of opening of the gate member to between about 20 degrees and 50 degrees and most preferably about 30 degrees when the third engagement formation is disengaged from the fourth engagement formation.

The abutment projection is preferably defined by a projection located on a proximal end of the gate member and is configured to abut against a lower portion of the first side member.

Lateral walls of the bulk material storage cradle and a floor of the bulk material storage are preferably infilled with cladding.

In a further aspect, the present disclosure provides a method of handling bulk material including the steps of:

operating a spreader with a crane, the spreader having a spreader body having a first engagement formation;

lowering the spreader onto a bulk material storage cradle having a first side member and a second side member, a gate member, and a second engagement formation disposed at a top portion of the first side member and a top portion of the second side member, wherein the first and second side members are selectively connectable with each other via at least one of: the spreader when the first engagement formation is engaged with the second engagement formation; and the gate member when the gate member is closed and extends between the first side member and the second side member, and the first and second side members define two opposing longitudinal side walls which are spaced relative to each other to define an internal bulk material storage receptacle,

securing the first and second engagement formations to secure the spreader to the bulk material storage cradle;

actuating a secondary actuation mechanism to selectively disengage one end of the gate member, to thereby open a base of the bulk material storage cradle and release any bulk material contained in the receptacle.

In a further aspect, the present disclosure provides a bulk material storage cradle couplable to a spreader, the bulk material storage cradle having:
a first side member and a second side member, the first and second side members defining two opposing longitudinal side walls which are spaced relative to each other to define an internal bulk material storage receptacle,
at least one gate member having a proximal end hingedly connected to a lower portion of the first side member and a distal end having a first engagement formation configured to selectively engage with a second engagement formation located at a lower portion of the second side member;

wherein the first engagement formation is selectively disengageable from the second engagement formation to release the gate member from the second side member, wherein the bulk material storage cradle further has a secondary actuation mechanism interfacing with and operable from the spreader, the first engagement formation is selectively controllable by the secondary actuation mechanism, such that the one of the third and fourth engagement formations is released to open the gate member.

The bulk material storage cradle preferably includes a plurality of angularly inclined guide surfaces located at or near a base of the cradle, the guide surfaces being configured to interact with corresponding abutment formations of a transport storage frame during nesting.

### BRIEF DESCRIPTION OF THE DRAWINGS

A preferred embodiment of the invention will now be described by way of specific example with reference to the accompanying drawings, in which

FIG. 1 is a perspective view of a spreader of the present invention;

FIG. 2 is a perspective view of a bulk material storage cradle of the present invention;

FIG. 3 is a perspective view of a transport storage frame of the present invention;

FIG. 4 depicts the log storage cradle nested in the transport storage frame;

FIG. 5 depicts the spreader lowered into position above the log storage cradle prior to engagement;

FIG. 6 depicts the log storage cradle filled with logs;

FIG. 7 Shows the spreader lowering onto the filled log storage cradle;

FIG. 8 Shows the spreader lifting the laden log storage cradle without the transport storage frame;

FIG. 9 is a perspective view showing the spreader and log storage cradle discharging the logs out of the bunk;

FIG. 10 is an end view showing the spreader and log storage cradle discharging the logs out of the bunk;

FIG. 11 shows the spreader lowering the log storage cradle into the transport storage frame and the gate members being closed;

FIG. 12 is a perspective view depicting the method of FIG. 11;

FIG. 12A is a detail of the gate member in an unlocked position but in close proximity to the vertical member with twistlock in a ready to lock position;

FIG. 12B shows the vertical member locked into the gate member with the twistlock rotated 90 degrees to a locked position;

FIG. 13 is an end view showing the spreader lowering the log storage cradle into the transport storage frame and the gate members being closed;

FIG. 13A is a detail of the hinge on the gate members which is restricted to an angle of 30 degrees to allow smooth discharge of the logs;

FIG. 14 is a front view of the transport storage frame with actuation mechanisms of the gate members;

FIG. 14A is an end view providing a detail of the locking and actuation mechanisms of the lower twistlock and connection to gate members;

FIG. 14B shows the twistlock land pin arrangement;

FIG. 14C is an end view of the vertical member of the log storage cradle connected to the gate members with the twistlock in the locked position;

FIG. 14D depicts the spreader locked in the lower log storage cradle with the lower twistlock of the vertical member of the log storage cradle positioned next to the gate members in the unlocked position ready to lock;

FIG. 14E depicts the spreader locked into the lower cradle with the lower twistlock of the vertical member of the log storage cradle locked into the gate member.

FIG. 15 is a perspective view of a log storage cradle of a second embodiment;

FIG. 16 depicts the log storage cradle of FIG. 15 secured to the spreader, with the gate members an open position for log discharge;

FIG. 17 depicts the log storage cradle of FIG. 15 secured to the spreader, with the gate members in a closed position;

FIG. 18 is a perspective view of a bulk material storage cradle of a second embodiment; and

FIG. 19 depicts the bulk material storage cradle of FIG. 18, in an open configuration, and engaged with a spreader.

### DETAILED DESCRIPTION OF THE PREFERRED EMBODIMENTS

There is disclosed herein an apparatus 50 and method for handling bulk material. In the embodiment depicted, the bulk material is shown and described with reference to timber logs 500. However, it will be appreciated that any bulk material may be accommodated, such as, but not limited to scrap metal, woodchips, earth, metal ores, coal, grains, cereals, sand, cement, gravel, salt etc.

The apparatus 50 includes a spreader 100, a log storage cradle 200 and a transport storage frame 300. The apparatus 50 is designed for handling cut logs 500, but could be used with other generally cylindrical, or at least elongated objects, or in fact in some embodiments, with bulk materials in general.

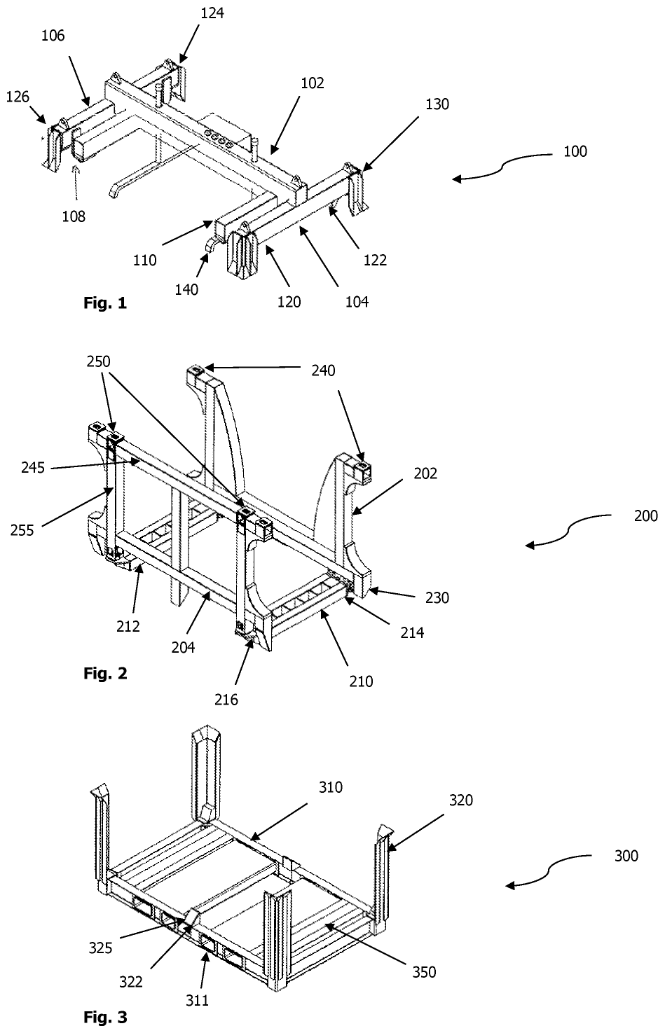

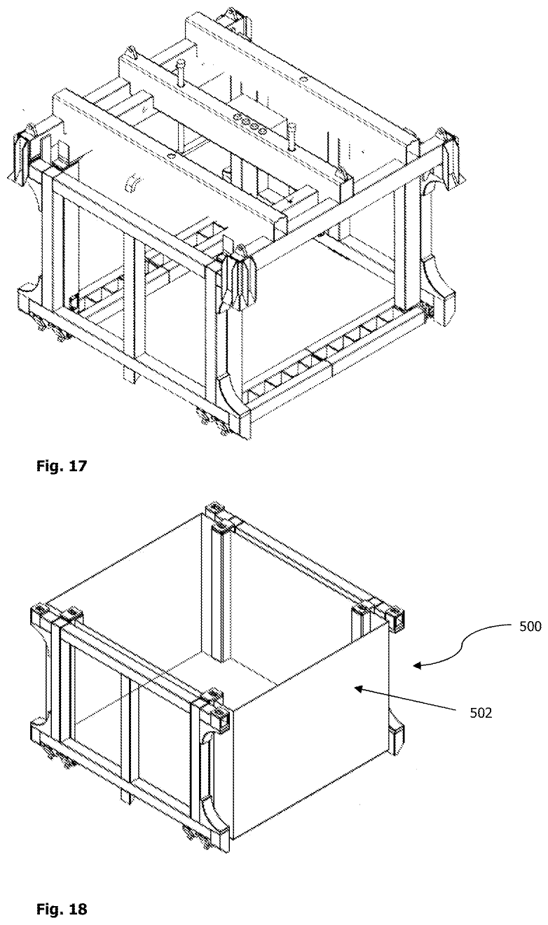

The apparatus 50 of FIGS. 1 to 17 relates predominantly to bulk log handling equipment for the timber industry. More specifically, the apparatus 50 relates to an attachment for a crane for the automated handling of logs for loading a ship.

The apparatus 50 provides a crane attachment in the form of the spreader 100 and together with the log storage cradle 200 and the transport storage frame 300, the apparatus 50 automates the log handling operation, to the extent that it removes the need for manual intervention and in particular obviates the need to drag chain or wire slings from under bundles inside the vessel. In addition, the apparatus 50 obviates the need for manually placing the wire or chain sling around the logs wharf-side.

The apparatus 50 keeps the functional advantages of an existing grab but reducing the weight on the crane attachment, thereby making the loading stage faster by increasing capacity per lift and having faster cycles to land and latch on log bundles.

### Spreader

A horizontal lifting attachment or spreader 100 is provided as an attachment for a crane that can be used with various types of cranes, such as wharf side cranes or ship based cranes.

The spreader 100 includes a longitudinally extending frame 102. A perpendicular cross-bar 104, 106 is located at each opposing end of the frame 102, such that the frame 102 and cross-bars 104, 106 together have a generally “I” shaped profile when viewed from above.

The spreader 100 includes two arms 108, 110 which extend perpendicularly away from one side of the frame 102. The arms 108, 110 are each located between and generally parallel with the perpendicular cross-bars 104, 106.

The spreader 100 is configured to automatically latch the log storage cradle 200 which is capable of storing cut logs.

In the embodiment depicted in the drawings, the spreader 100 includes a primary actuation mechanism which is provided by a first engagement formation defined by first set twist locks, comprising four twist locks 120, 122, 124, 126 which are located generally at or near an underside of each of the four corners of the spreader 100, at distal ends of each of the perpendicular cross-bars 104, 106.

In one embodiment, the twist locks 120, 122, 124, 126 are mushroom head locking twist locks 120, 122, 124, 126 located at each corner that are capable of rotation by 90 degrees from a locked to an unlocked position. The twist locks 120, 122, 124, 126 engage with a second engagement formation in the form of four corner castings or other such corresponding female members.

The spreader 100 also has a secondary actuation mechanism 140. The secondary actuation mechanism 140 controls a latch mechanism located at or near the distal end of each of the arms 108, 110. The latch mechanism is defined by third and fourth engagement formations, which may be twist locks and corner casting type latch mechanisms, or alternatively another latch mechanism may be deployed.

The primary and secondary actuation means are independently operable.

The spreader 100 includes corner guides 130 in the form of female rebated corners which are located at each end of the perpendicular cross-bars 104, 106. The corner guides 130 assist the crane operator to align the spreader 100 with the log storage cradle 200 for fast docking and allowing for accurate positioning of the spreader 100 with respect to the log storage cradle 200.

### Log Storage Cradle

FIG. 2 shows the log storage cradle 200 in isolation. The log storage cradle 200 is suitable for supporting a bundle of logs 500. The logs 500 can be loaded from one side or from above.

The log storage cradle 200 has a generally “U” shaped profile when viewed from the end view, such that it can hold a plurality of stacked logs, regardless of the length of the logs, and the logs may project beyond the ends. The logs 500 are loaded into the log storage cradle 200 with the centre of each log being located at or near the longitudinal mid-point of the log storage cradle 200 for balance purposes.

The log storage cradle 200 has a first side member defined by a frame 202 and a second side member defined by a frame 204. The frames 202, 204 define the two opposing, lateral sides of the log storage cradle 200.

The frames 202, 204 are connected with at least one and preferably a pair of horizontal gates or floor members 210, 212, that are hinged at one side, and selectively detachable on the opposing side to define a hinged gate. The gate members 210, 212 each have a proximal end 214 that is pivotally secured to the first side frame 202, and thereby pivotal about an axis which is generally parallel with a longitudinal axis of the log storage cradle 200. The gate members 210, 212 each have a distal end 216 that is selectively securable to the opposing side frame 204.

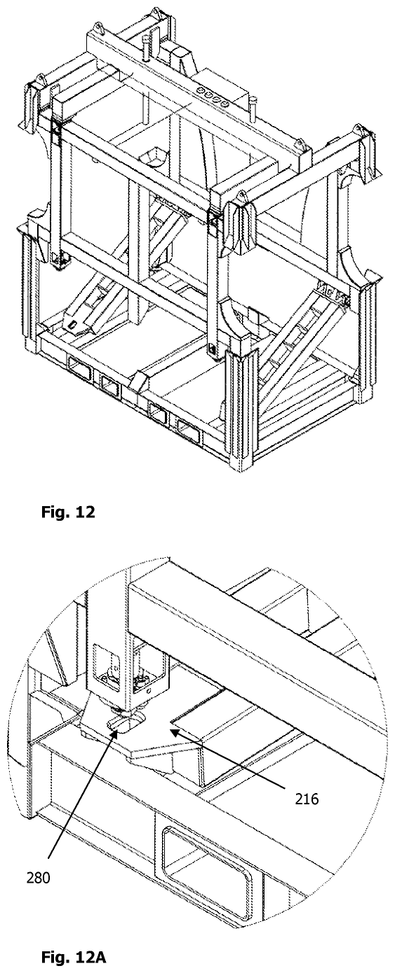

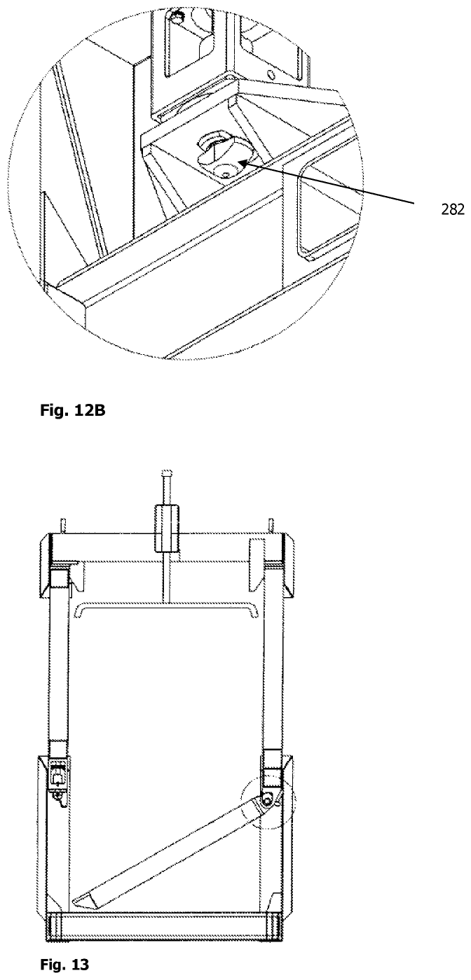

The distal ends 216 of the gate members are locked to the frame with twist locks, as depicted for example in FIG. 12A.

The upper beam or other such structural member of the frames 202, 204 have second engagement formations in the form of four female twist lock apertures 250 such as corner castings, for engagement with the twist locks 120, 122, 124, 126, and when landed and rotated by 90 degrees the spreader 100 is locked and secured relative to the log storage cradle 200 to allow hoisting of the log storage cradle 200. It will be appreciated that another arrangement could be deployed for the first and second engagement formations which selectively secure the spreader 100 to the log storage cradle 200.

The upper beam or other such structural member 245 also has two additional apertures for the secondary actuation regarding unlocking of the gate members 210, 212.

In particular, an additional set of actuators on the spreader 100 is engageable with two apertures 250 in the upper portions of the frame 204. Each aperture 250 is connected by a shaft 270 through a vertical member 255 to an unlocking point at the lower portion of the vertical member 255 where it connected to one of the gate members 210, 212.

Each gate member 210, 212 has a proximal end 214 hingedly connected to a lower portion of the first side member 202 and a distal end 216 having a third engagement formation configured to selectively engage with a fourth engagement formation located at a lower portion of the second side member 204.

This enables the selective detachment of one end of each gate member 210, 212 relative to the frame 204. Once detached at one side, the gate member 210, 212 hinges on the opposite lower corner allowing the floor of the log storage cradle 200 to open and the logs 500 to be discharged into the hold of the vessel.

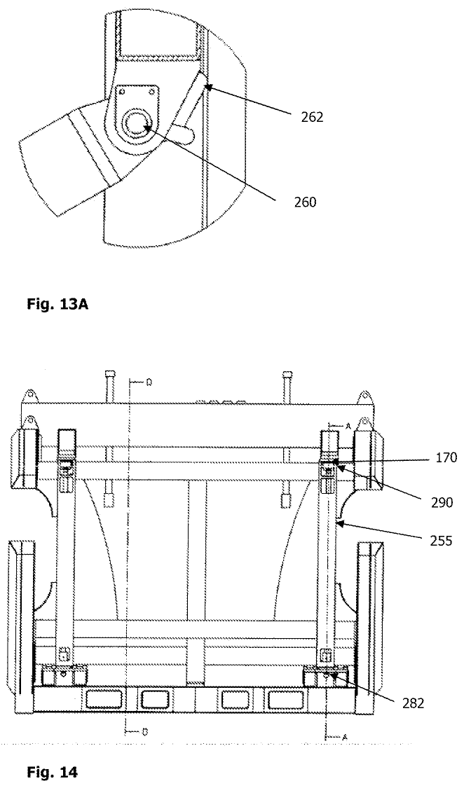

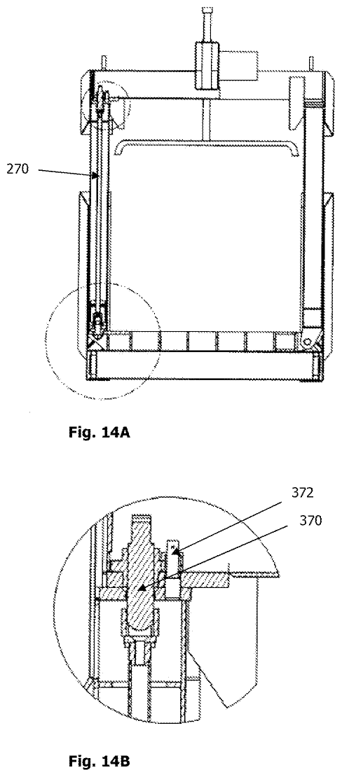

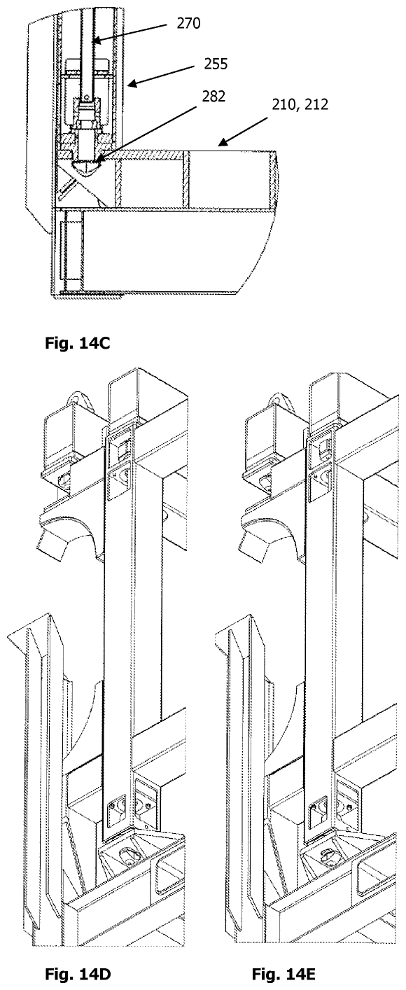

Referring to FIG. 14B, the spreader 100 includes a male projection 370 defining a locking member 152 capable of supporting a load. The spreader 100 will have two additional actuation mechanisms that engage via a shaft or link bar 270 located inside the vertical members 255 of the log storage cradle 200. The actuation of this link bar 270 from the spreader 100 above allows the unlocking of one side of the floor or gate members 210, 212.

Each of the frames 202, 204 includes a plurality of downwardly extending angled projections 230. The projections 230 are preferably located around the perimeter, such that one angled projection 230 is located at each corner, and two are located generally centrally between the longitudinal ends.

In one embodiment, the horizontal attachment of the log storage cradle 200 includes a landing pin.

Once positioned and landed in the ship, then the landing pin overrides a mechanical interlock connecting the gate members 210, 212 to the frame 204. In this embodiment, the spreader 100 allows the gate members 210, 212 to detach on one side thus opening the bottom of log storage cradle 200 at one side. A hinge on the other side allows the gate members 210, 212 to drop away as the crane hoists, allowing gentle discharge of the logs 500.

### Transport Storage Frame

FIG. 3 depicts the horizontal transport storage frame 300 that houses the log storage cradle 200 in a nested configuration for horizontal transport. The transport storage frame 300 supports the log storage cradle 200 during transport, and provides a mechanism for closing the gate members 210, 212 once opened, thereby returning the log storage cradle 200 to the initial, locked position.

The transport storage frame 300 is configured to support the log storage cradle 200 for horizontal transport by truck or other transport means.

The transport storage frame 300 has a rigid base frame 310 having laterally located, vertically extending passages 311 configured to receive the tines of a fork lift or other such vehicle.

The rigid base frame 310 has four vertically extending posts 320, one projecting from each corner. When viewed from above, the posts are each generally “L” shaped, and together define the corners of a rectangle. The uppermost, distal end of each post 320 is outwardly flared, to define a guide surface for receiving and guiding the log storage cradle 200 when it is lowered vertically.

In the embodiment depicted, the rigid base frame 310 includes six guide blocks 325, located around the perimeter, such that one guide block 325 is located at each corner, and two guide blocks 325 are located generally centrally between the longitudinal ends.

The guide blocks 325 are each angled at about 45 degrees relative to vertical, and define a guide surface 322. The guide surface 322 is configured to engage with the downwardly extending corresponding angled projections 230 of the log storage cradle 200.

The rigid base frame 310 of the transport storage frame 300 includes a pair of skid surfaces 350. The skid surfaces 350 are located directly beneath the gate members 210, 212 of the log storage cradle 200.

The operation of the apparatus 50 will now be described.

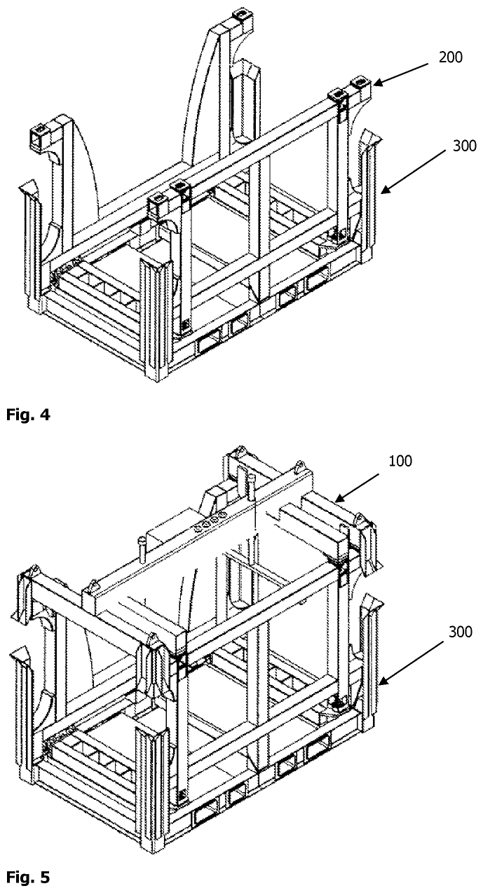

Cut logs 500 are positioned into the log storage cradle 200 which is nested within the transport storage frame 300 in the yard until the logs 500 have been filled using conventional lifting equipment. FIG. 4 depicts the combined log storage cradle 200 and the transport storage frame 300.

The log storage cradle 200 and transport storage frame 300 is then delivered by horizontal transport (such as a truck and trailer) to the ship. Once it reaches the vessel from a storage yard, the storage cradle 200 on the trailer is then connected to the spreader 100 suspended from a crane hook for lifting. FIG. 5 depicts the spreader 100 lowered into position on top of the log storage cradle 200, ready to connect.

The spreader 100 attaches to the log storage cradle 200 while still on the trailer.

The spreader 100 and log storage cradle 200 can be selectively engaged by securing the first set twist locks 120, 122, 124, 126 of the spreader 100 with corner castings 240 of the log storage cradle 200, at which point the first and second engagement formations engage. Then the spreader 100 and log storage cradle 200 can be hoisted by the crane into the ship.

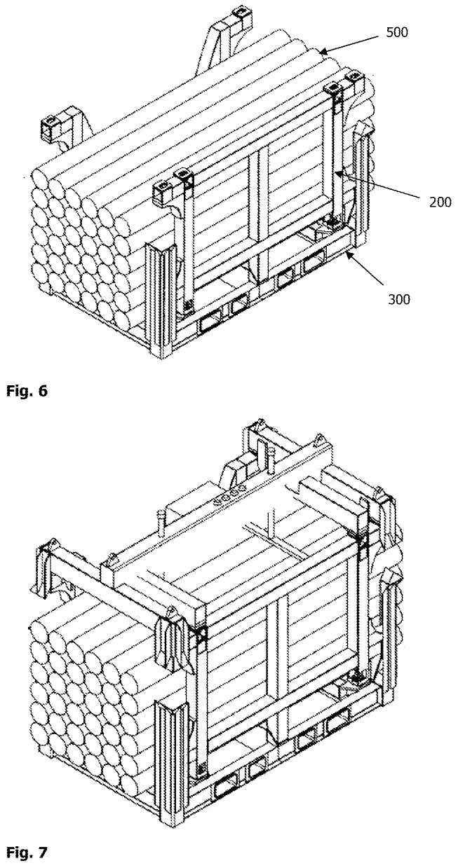

FIG. 6 depicts the log storage cradle 200 filled with logs 500. This is ready to be lifted into the ship. FIG. 7 depicts the spreader lowered down onto the filled log storage cradle 200 and locking into position.

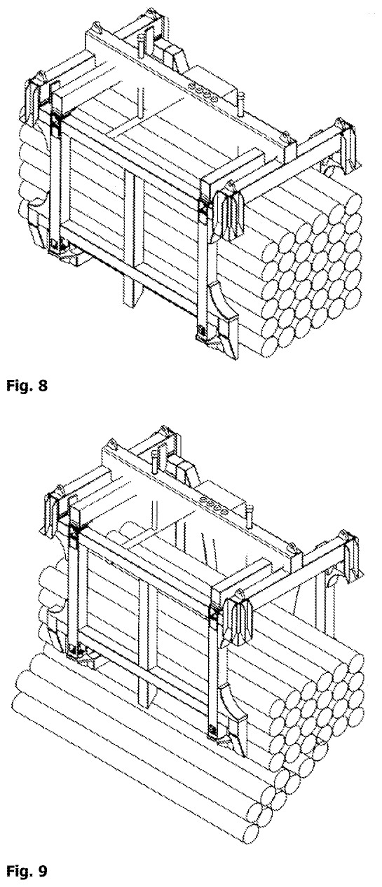

FIG. 8 depicts the spreader 100 lifting the laden log storage cradle 200, lifted clear of the transport storage frame 300, ready to position the logs 500 in the ship.

During lifting of the spreader 100, the log storage cradle 200 and logs are lifted, but the transport storage frame remains on the trailer.

Once the logs are positioned at the desired location with the ship, the horizontal gate members 210, 212 are released to empty the logs into the vessel. This releasing is achieved by actuating male projection 170, which results in rotation of the vertical bar 270 about a vertical axis.

Referring to FIGS. 12A and 12B, each gate member 210, 212 has a proximal end 214 hingedly connected to a lower portion of the first side member 202 and a distal end 216 having a third engagement formation, in the form of a female aperture 280. The vertical bar has a fourth engagement formation 282 connected or otherwise formed on the lower end. The fourth engagement formation 282 is a mushroom headed twistlock or other such formation. The actuation of the shaft 270 from the spreader 100 above allows the unlocking of one side of the floor or gate members 210, 212.

FIG. 14 is a front view of the apparatus 50 and method for handling timber logs 500 showing the actuation mechanisms of the gate members 210, 212. The log storage cradle 200 includes a housing that has a female engagement means 290. The female engagement means 290 is connected to the vertical shaft 270 which runs within the member 255, as shown in FIG. 14A, to the male twistlock 282 at the opposing bottom end. This lower twistlock 282 locks or unlocks a distal end of each gate members 210, 212. The spreader actuating male projection 170 will engage the female member 290 and rotate it through 90 degrees driving the shaft 270 and thus the connected lower twistlock 282.

FIG. 14A is an end view with detail of the locking and actuation mechanisms of the lower twistlock 282 and connection to lower gate members 210, 212. The gate members 210, 212 has a female aperture for connection to the twistlock 282 in the lower portion of the shaft 270 which allows the twistlock 282 to lock and unlock into the distal end of one of the gate members 210, 212.

The gate members 210, 212 each rotate about the proximal end 214, allowing the discharge of logs into the vessel. The range of rotation is limited to a range of about 20 to 50 degrees, and most preferably about 30 degrees, to direct the discharge of logs 500 to occur in a more orderly and predictable manner.

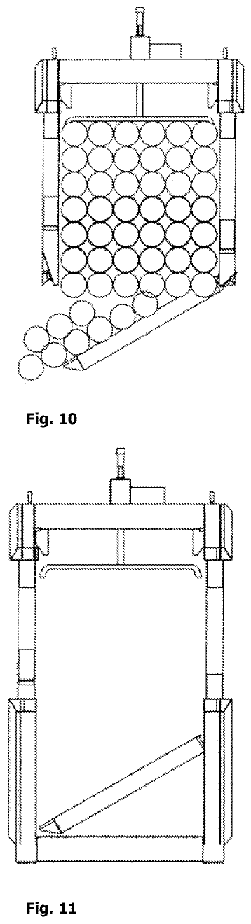

FIG. 9 is a perspective view showing the spreader 100 and log storage cradle 200 assembled and discharging the logs 500 out of the log bunk or receptacle within the log storage cradle 200. Similarly, FIG. 10 shows the spreader 100 and log storage cradle 200 combination discharging the logs out of the bunk in end view. As shown in that figure, the angle of opening of the gate members 210, 212 is preferably limited to less than 90 degrees, for example, to about 30 degrees below horizontal, and the gate members 210, 212 are prevented from opening all the way to a vertical orientation, such that the opening on the underside of the bunk is significantly less than the width of the bunk.

FIG. 13A shows a close up of the hinge 260 of the gate members 210, 212. The hinge 260 includes an abutment projection 262 which abuts against the frame 202 to restrict the angle of opening to about 30 degrees to allow smooth, orderly discharge of the logs.

The hinge 260 also includes an internal spring. The spring assists to limit the range of opening of the gate members 210, 212 after the logs 500 have been discharged. In practice, the springs ensure that the gate members 210, 212 do not open beyond a position which would not be closable during abutment with the transport storage frame 300.

After discharge of the logs 500, the empty log storage cradle 200 is returned to the trailer. FIG. 11 shows the spreader 100 lowering the log storage cradle 200 back into the transport storage frame 300 and the gate members 210, 212 being closed. FIG. 12 is an isometric view depicting the same stage in the process as FIG. 11. Furthermore, FIG. 13 is similar to FIG. 11 in end view.

The spreader 100 then lowers the open log storage cradle 200 back to the quay side and under gravity the gate members 210, 212 are pushed back into position relocking them for subsequent reuse. This occurs due to the distal ends 216 of the gate member 210, 212 abutting against the skid surfaces 350.

FIG. 12A is a detail view of one of the gate members 210, 212 in the unlocked position but in close proximity to the base of the vertical member 255 with twistlock 282 in the ready to lock position. FIG. 12B shows the subsequent stage in the process with the vertical member 255 locked into the gate members 210, 212 with the twistlock 282 rotated 90 degrees to the locked position.

FIG. 14D shows the spreader 100 locked in the log storage cradle 200 with the lower twistlock 282 of the vertical member 255 of the log storage cradle 200 positioned next to one of the gate members 210, 212 in the unlocked position ready to lock. FIG. 14E shows the spreader 100 locked into the lower log storage cradle 200 with the lower twistlock 282 of the vertical member 255 of the log storage cradle 200 locked into one of the gate members 210, 212.

FIG. 14C is an end view of the vertical member 255 of the log storage cradle 200 connected to one of the gate members 210, 212 with the twistlock 282 in the locked position.

FIG. 14B shows the twistlock land pin arrangement 370. The land pin 372 is a mechanical interlock that prevents actuation of the shaft 270 until it is depressed. It can only be depressed when the whole log storage cradle 200 is in the landed position, pushing the gate members 210, 212 against the vertical member 255.

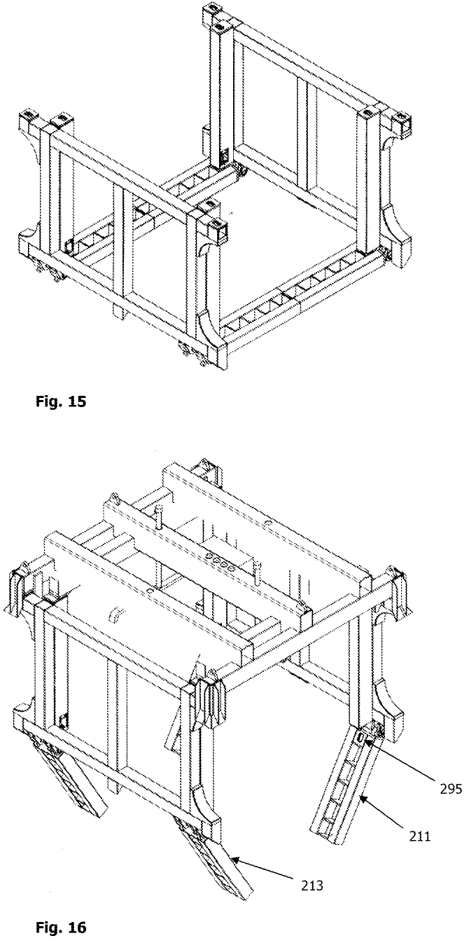

FIGS. 15 to 17 depict an alternative embodiment of the log storage cradle 200 in which the gate members 210, 212 are each defined by two longitudinally continuous gates 211, 213 that open centrally. The open position is disclosed in FIG. 16.

In the arrangement of FIGS. 15 to 17, for example as shown in FIG. 15, the spreader 100 has four actuation points with the gate members 210, 212 (as opposed to two for the earlier described embodiment). In this embodiment, referring to FIG. 16 for example, an elongated aperture 295 for receiving the male twist lock is located close to the proximal end, so the hinge point and the locking twist lock for each gate 211, 213 is in close proximity. In a further embodiment not shown, latching may occur centrally, where the gates 211, 213 meet in the closed position.

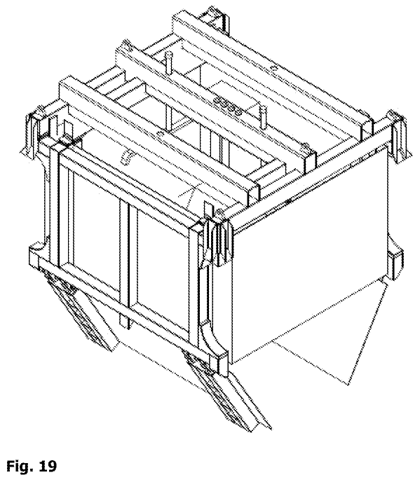

FIGS. 18 and 19 show a bulk material storage cradle 500 of the apparatus 50. The bulk material storage cradle 500 is structurally very similar to the aforementioned log storage cradle 200, however the walls and floor are infilled with cladding 502. This may be in the form of weathering steel plate or some other structural material which is able to support the weight of bulk materials such as woodchips, earth, metal ores, coal, grains, cereals, sand, cement, gravel, salt etc.

The operation of the bulk material storage cradle 500 is functionally the same as the earlier described embodiments, with the only difference being the inclusion of the cladding 500 to contain the bulk material.

Advantageously the apparatus 50 reduces labour costs as it allows handling of logs or other bulk material without the need for stevedores. The system compares favourably and is faster than the manual system without the high safety risk.

Although the invention has been described with reference to specific examples, it will be appreciated by those skilled in the art that the invention may be embodied in many other forms.

What is claimed is:

1. An apparatus for handling bulk materials, the apparatus comprising:
a spreader configured for attachment to a crane, the spreader having a spreader body having a first engagement formation; and
a bulk material storage cradle having:
a first side member and a second side member,
a second engagement formation disposed at a top portion of the first side member and a top portion of the second side member, wherein the first engagement formation is selectively engageable with the second engagement formation to secure the spreader to the bulk material storage cradle, and
at least one gate member having a proximal end hingedly connected to a lower portion of the first side member and a distal end having a third engagement formation configured to selectively engage with a fourth engagement formation located at a lower portion of the second side member;
wherein the first side member and the second side member are selectively connectable via at least one of: the spreader when the first engagement formation is engaged with the second engagement formation; and the gate member when the third engagement formation is engaged with the fourth engagement formation,
wherein, when the first and the second side members are connected via at least one of the spreader and the gate member, the first and the second side members are spaced relative to each other and define two opposing longitudinal side walls of the bulk material storage cradle and form an internal bulk material storage receptacle;
further wherein the third engagement formation is selectively disengageable from the fourth engagement formation to release the gate member from the second side member.

2. The apparatus of claim 1, wherein the bulk material storage cradle further has a secondary actuation mechanism interfacing with and operable from the spreader, one of the third and fourth engagement formations is selectively controllable by the secondary actuation mechanism, such that the one of the third and fourth engagement formations is released to open the gate member.

3. The apparatus of claim 1, further comprising a transport storage frame, the transport storage frame including a rigid base frame and four vertically extending corner posts.

4. The apparatus of claim 3, wherein the rigid base and corner posts define a receptacle configured to receive the bulk material storage cradle.

5. The apparatus of claim 4, wherein the transport storage frame includes a plurality of guide surfaces, the guide surfaces are configured to interact with corresponding abutment formations of the bulk material storage cradle during nesting.

6. The apparatus of claim 5, wherein the guide surfaces are located on angularly inclined projections, and the abutment formations are defined by complimentary inclined surfaces located on projections located at or near a bottom of each of the first and second side members of the bulk material storage cradle.

7. The apparatus of claim 3, wherein the rigid base frame includes a skid surface located directly beneath each gate member and configured to guide the gate member from an open position to a closed position as the bulk material storage cradle is lowered into the transport storage frame.

8. The apparatus of claim 1, wherein an abutment projection restricts an angle of opening of the gate member to between about 20 degrees and 50 degrees and most preferably about 30 degrees when the third engagement formation is disengaged from the fourth engagement formation.

9. The apparatus of claim 8, wherein the abutment projection is defined by a projection located on a proximal end of the gate member and is configured to abut against a lower portion of the first side member.

10. The apparatus of claim 1, wherein lateral walls of the bulk material storage cradle and a floor of the bulk material storage are infilled with cladding.

11. A bulk material storage cradle having:
a first side member and a second side member,
a second engagement formation disposed at a top portion of the first side member and a top portion of the second side member, wherein the second engagement formation is adapted to be selectively engageable with a first engagement formation of a spreader to secure the bulk material storage cradle to the spreader, and
at least one gate member having a proximal end hingedly connected to a lower portion of the first side member and a distal end having a third engagement formation configured to selectively engage with a fourth engagement formation located at a lower portion of the second side member;
wherein the first side member and a second side member are selectively connectable via at least one of: the spreader when the first engagement formation is engaged with the second engagement formation; and the gate member when the third engagement formation is engaged with the fourth engagement formation,
wherein, when the first and the second side members are connected via at least one of the spreader and the gate member, the first and the second side members are spaced relative to each other and define two opposing longitudinal side walls of the bulk material storage cradle and form an internal bulk material storage receptacle;
further wherein the third engagement formation is selectively disengageable from the fourth engagement formation to release the gate member from the second side member.

12. The bulk material storage cradle according to claim 11, wherein the bulk material storage cradle does not have end walls to connect the first side member to the second side member.

13. A system for handling bulk materials, the system comprising:
a spreader configured for attachment to a crane, the spreader having a spreader body having a first engagement formation; and
a bulk material storage cradle having:
a first side member and a second side member,
a second engagement formation disposed at a top portion of the first side member and a top portion of the second side member, wherein the first engagement formation is selectively engageable with the second engagement formation to secure the spreader to the bulk material storage cradle,
at least one gate member having a proximal end hingedly connected to a lower portion of the first side member and a distal end having a third engagement formation configured to selectively engage with a fourth engagement formation located at a lower portion of the second side member;
wherein the first side member and the second side member are selectively connectable via at least one of: the spreader when the first engagement formation is engaged with the second engagement formation; and the gate member when the third engagement formation is engaged with the fourth engagement formation,
wherein, when the first and the second side members are connected via at least one of the spreader and the gate member, the first and the second side members are spaced relative to each other and define two opposing longitudinal side walls of the bulk material storage cradle and form an internal bulk material storage receptacle;
further wherein the third engagement formation is selectively disengageable from the fourth engagement formation to release the gate member from the second side member; and
a transport storage frame including a rigid base frame and four vertically extending corner posts.

14. The system according claim 13, wherein the rigid base and corner posts define a receptacle configured to receive the bulk material storage cradle.

15. The system according to claim 14,
wherein the first side member and the second side member of the bulk material storage cradle each has an angled projection extending downwardly from the lower portion, and the transport storage frame comprises angled guide blocks corresponding to and adapted to engage with the angled projections of the first side member and the second side member.

16. The system according to claim 15, wherein the angled projections and the guide blocks are each angled at about 45 degrees relative to vertical, and define corresponding guide surfaces, the guide surfaces being configured to prevent the first and second side members from moving away from a generally vertical orientation.

17. An apparatus for handling bulk materials, the apparatus comprising:
a spreader configured for attachment to a crane, the spreader having a spreader body having a first engagement formation; and
a bulk material storage cradle having:
a first side member and a second side member, the first and second side members defining two opposing longitudinal side walls which are spaced relative to each other to define an internal bulk material storage receptacle,
a second engagement formation, and
at least one gate member having a proximal end hingedly connected to a lower portion of the first side member and a distal end having a third engagement formation configured to selectively engage with a fourth engagement formation located at a lower portion of the second side member;
wherein the first engagement formation is selectively engageable with the second engagement formation to secure the spreader to the bulk material storage cradle;
further wherein the third engagement formation is selectively disengageable from the fourth engagement formation to release the gate member from the second side member,
wherein the bulk material storage cradle further has a secondary actuation mechanism interfacing with and operable from the spreader, one of the third and fourth engagement formations is selectively controllable by the secondary actuation mechanism, such that the one of the third and fourth engagement formations is released to open the gate member.

18. The apparatus of claim 17, wherein the secondary actuation mechanism includes a vertically extending shaft which extends through the second side member, an upper end of the shaft being engageable by a male projection of the spreader and a lower end of the shaft being connected to the fourth engagement formation.

19. The apparatus of claim 18, wherein the third engagement formation is an aperture and the fourth engagement formation is a male twistlock.

20. A method of handling bulk material including the steps of:
operating a spreader with a crane, the spreader having a spreader body having a first engagement formation;
lowering the spreader onto a bulk material storage cradle having a first side member and a second side member, a gate member, and a second engagement formation disposed at a top portion of the first side member and a top portion of the second side member, wherein the first and second side members are selectively connectable with each other via at least one of: the spreader when the first engagement formation is engaged with the second engagement formation; and the gate member when the gate member is closed and extends between the first side member and the second side member, and the first and second side members define two opposing longitudinal side walls which are spaced relative to each other to define an internal bulk material storage receptacle,
securing the first and second engagement formations to secure the spreader to the bulk material storage cradle;
actuating a secondary actuation mechanism to selectively disengage one end of the gate member to thereby open a base of the bulk material storage cradle and release any bulk material contained in the receptacle.

21. A bulk material storage cradle couplable to a spreader, the bulk material storage cradle having:
a first side member and a second side member, the first and second side members defining two opposing longitudinal side walls which are spaced relative to each other to define an internal bulk material storage receptacle,
at least one gate member having a proximal end hingedly connected to a lower portion of the first side member and a distal end having a first engagement formation configured to selectively engage with a second engagement formation located at a lower portion of the second side member;
wherein the first engagement formation is selectively disengageable from the second engagement formation to release the gate member from the second side member, wherein the bulk material storage cradle further has a secondary actuation mechanism interfacing with and operable from the spreader, the first engagement formation is selectively controllable by the secondary actuation mechanism, such that the one of the third and fourth engagement formations is released to open the gate member.

22. The bulk material storage cradle of claim 21, including a plurality of angularly inclined guide surfaces located at or near a base of the cradle, the guide surfaces being configured to interact with corresponding abutment formations of a transport storage frame during nesting.
